(19) United States
(12) Patent Application Publication
(10) Pub. No.: US 2025/0178383 A1
(43) Pub. Date: Jun. 5, 2025

(54) FASTENING ELEMENT FOR FASTENING ELECTRONIC DEVICES ON TIRES AND MANUFACTURING METHOD OF A TIRE PROVIDED WITH SAID FASTENING ELEMENT

(71) Applicant: YOKOHAMA TWS SOCIETA' PER AZIONI, TIVOLI (RM) (IT)

(72) Inventors: Andrea EVANGELISTI, ALBANO LAZIALE (RM) (IT); Enrico PIERALICE, ROMA (RM) (IT); Davide MARINUCCI, Tivoli (RM) (IT)

(73) Assignee: YOKOHAMA TWS SOCIETA' PER AZIONI, TIVOLI (RM) (IT)

(21) Appl. No.: 18/842,211

(22) PCT Filed: Feb. 2, 2023
(86) PCT No.: PCT/IB2023/050925

§ 371 Date: Aug. 28, 2024

(30) Foreign Application Priority Data
Mar. 16, 2022 (IT) 102022000005120

(51) Int. Cl. B60C 23/04; B29D 30/00; B29K 7/00; B29K 9/06; B29K 105/00; B29K 507/04

(52) U.S. Cl. CPC B60C 23/0493; B29D 30/0061; B29D 2030/0072; B29K 2007/00; B29K 2009/06; B29K 2105/0038; B29K 2507/04

(57) ABSTRACT

Vehicle wheel tire including a fastening element of deformable elastomeric material for an electronic device. Each fastening element is integral with a tire internal base wall and/or internal side wall and includes a base portion, having a fastening surface fastened on the internal base wall and/or internal side wall; a retaining portion, formed in a single piece with the base portion and having an upper surface facing away from the fastening surface; and a blind hole extending into the retaining portion, and faces the upper surface, and has a side wall and bottom wall. The base portion has a maximum dimension, measured on a plane parallel to the fastening surface, between 55 and 75 mm. Blind hole maximum internal width is less than a retaining portion has a minimum dimension of between 20 and 30 mm measured on a plane parallel to the upper surface.

The present invention concerns in general the technical field of tires and, in particular, an element for fastening electronic devices on a tire, and a manufacturing method of a tire provided with said fastening element. Even more in particular, the present invention concerns a rubber fastening element, technically called patch, which is adapted to retain one or more sensors positioned inside the tire when the latter is fitted on the respective rim, in such a way that the patch is in direct contact with the internal wall, technically called liner or inner liner, of the tire.

On many types of vehicles, both high performance motor vehicles and agricultural vehicles, vehicles for earth movement and/or for goods lifting and handling, it is necessary to monitor the operating conditions of the tires and, if necessary, keep track of the evolution over time of given parameters characteristic of said operation. These parameters can comprise, for example, the temperature, the pressure, the inertial characteristics of the tire, etc. It may also be expedient to detect other intrinsic parameters of the tires such as, for example, a unique tire identification code (which can be obtained by means of RFID technology, use of bar codes/QR codes, etc.).

Inside each tire, one or more electronic detection devices can therefore be fitted which are typically configured to acquire, filter, store data and send said data to a processing unit, which can be fitted on board the vehicle, and likewise one or more batteries to electrically power all the above-mentioned electronic devices. The processing unit is configured to acquire the data and process said data in order to provide information on the tire. These electronic devices are usually installed in patches which, in turn, are made integral on the internal wall of the tire. For said purpose, the patches are made of rubber or in any case an elastomeric material compatible with the component material of the tire.

For example, document EP-A-3774407, also published as WO 2019/186069 A1, discloses a tire provided with elements for the fastening of electronic devices according to the preamble of claim 1. More specifically, document EP-A-3774407 discloses a patch which is made of a specific elastomeric material and is designed for fastening of an electronic device on an internal wall of a tire for vehicles, in particular motor vehicles with high power and performance. The patch comprises a lower surface, which is designed to adhere on the internal wall of the tire, and an upper surface, which encloses an inner volume adapted to receive and retain one or more electronic devices. In particular, the inner volume of the patch is sized in such a way as to completely incorporate each electronic device. This means that the patch as a whole must have relatively large overall dimensions, such as to incorporate therein all the most common electronic devices that operate as sensors and/or as auxiliary equipment for said sensors. Consequently, specific tools are required in order to correctly insert each electronic device in the inner volume of the patch.

In addition, the fact that the patch disclosed in document EP-A-3774407 completely incorporates therein each electronic device can cause interferences with accurate detection of the inertial parameters of the tire. In fact, since each electronic device is completely in contact with the elastomeric material that composes the patch, and therefore also with the material that composes the tire, each electronic device can measure less accurately the variations connected with the rolling dynamics of the tire. In other words, due to the shape of the patch that almost completely encloses each electronic device, the latter can receive signals less representative of the exact rolling dynamics of the tire, because these signals also contain disturbances connected with the structural response of the patch. The accuracy of the contact between each electronic device and the tire is in fact directly proportional to the precision of the inertial signal provided by the electronic device itself. The patch therefore represents an additional, non-negligible element positioned between the electronic device and the tire.

The patch disclosed in document EP-A-3774407 is furthermore made of a non-halogenated butyl rubber-based compound, which is not the same rubber compound of which a tire is usually made. This difference in materials can negatively affect the pre-vulcanization process of the patch, in particular the operations prior to affixing of the patch on the tire in order to obtain perfect adhesion therewith.

Further elements for the fastening of electronic devices on a tire are disclosed in documents US 2019/160895 A1, WO 2008/143326 A1, U.S. Pat. No. 10,994,494 B2, U.S. Pat. No. 9,694,632 B2 and U.S. Pat. No. 8,863,570 B2.

The object of the present invention is therefore to provide an element for fastening electronic devices on a tire, and a manufacturing method of a tire provided with said fastening element, which are capable of solving the above-mentioned drawbacks of the prior art in an extremely simple, inexpensive and particularly functional manner.

In detail, an object of the present invention is to provide an element for fastening electronic devices on a tire that has limited overall dimensions as far as possible and in any case such as to minimize all possible interferences with the electronic devices during rolling of the tire.

Another object of the present invention is to provide an element for fastening electronic devices on a tire which is capable of effectively retaining one or more electronic devices of any shape and size.

A further object of the present invention is to provide an element for fastening electronic devices on a tire that does not require the use of specific tools in order to correctly insert each electronic device inside the fastening element.

A further object of the present invention is to provide a manufacturing method of a tire provided with an element for fastening electronic devices which is simpler, more rapid and effective than the analogous manufacturing methods of known type.

These and other objects according to the present invention are achieved by providing an element for fastening electronic devices on a tire, and a manufacturing method of a tire provided with said fastening element, as disclosed in the independent claims.

Further features of the invention are highlighted by the dependent claims, which form an integral part of the present description.

The features and advantages of an element for fastening electronic devices on a tire and of a manufacturing method of a tire provided with said fastening element according to the present invention will become clearer from the following description, provided by way of non-limiting example, referring to the attached schematic drawings in which:

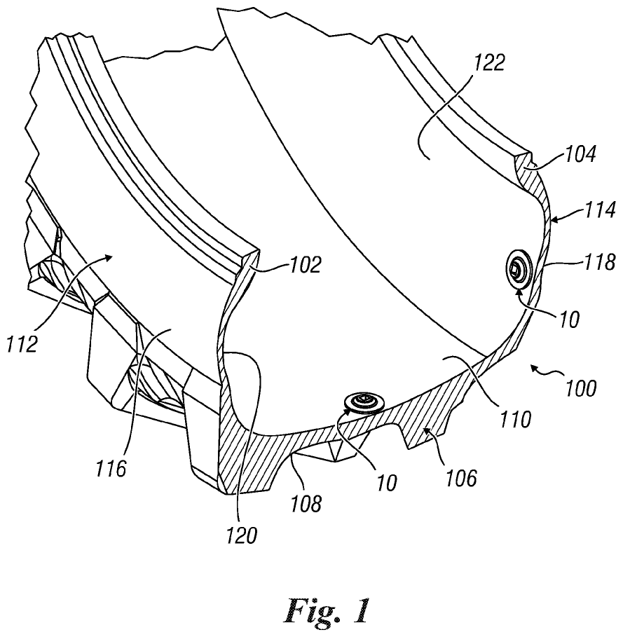

FIG. 1 is a perspective sectional view of a tire provided, by way of example, with a pair of elements for the fastening of electronic devices according to the present invention;

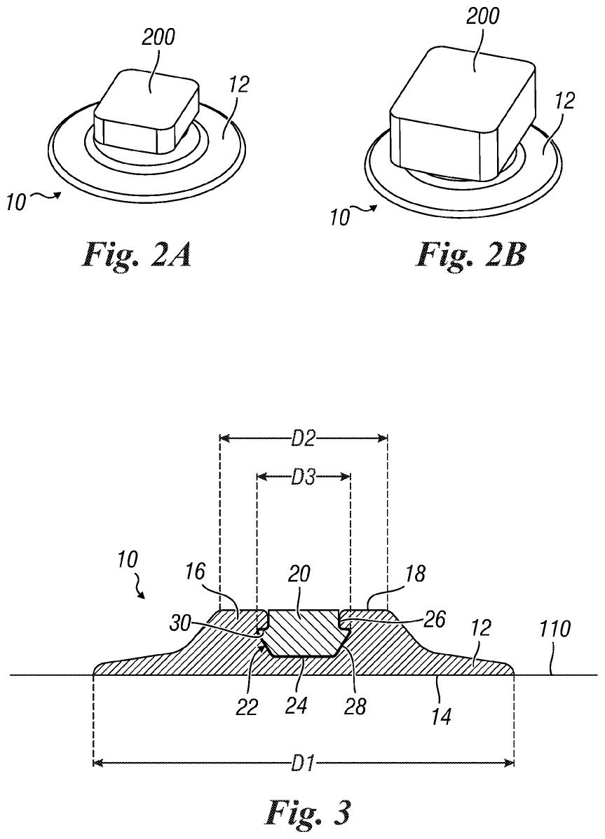

FIGS. 2A and 2B are perspective views of elements for the fastening of electronic devices according to the present invention, provided with respective electronic devices having different dimensions;

FIG. 3 is a cross-sectional view of an element for fastening electronic devices according to the present invention;

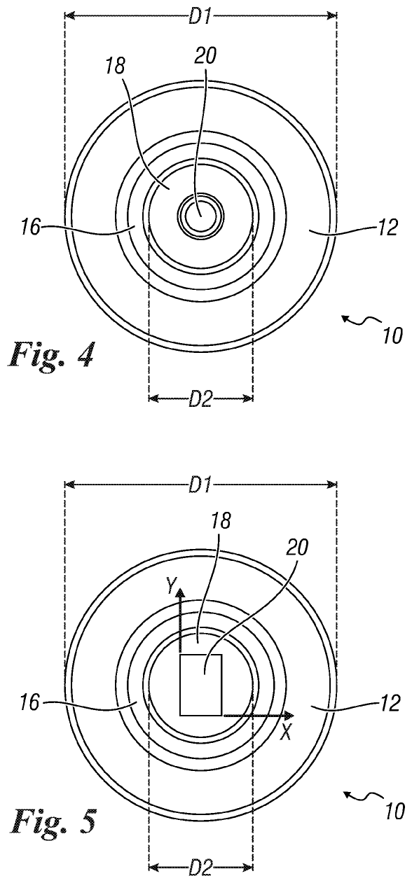

FIG. 4 is an overhead plan view of a first embodiment of the element for fastening electronic devices according to the present invention;

FIG. 5 is an overhead plan view of a second embodiment of the element for fastening electronic devices according to the present invention;

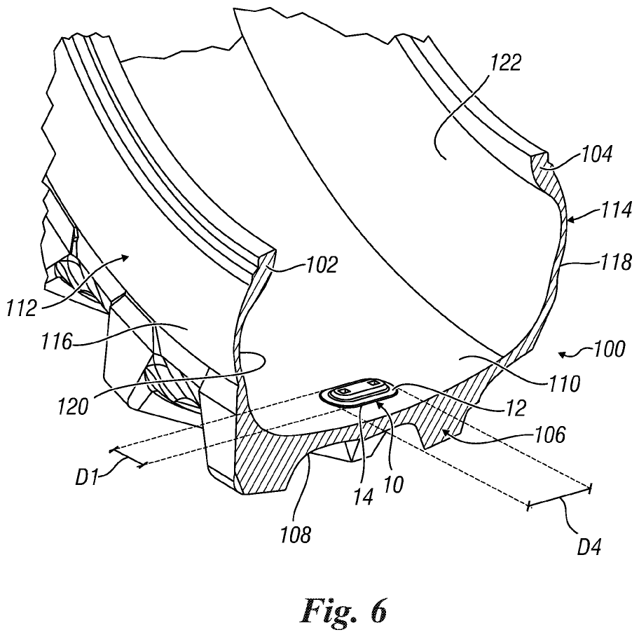

FIG. 6 is a sectional perspective view of a tire provided with a third embodiment of the element for fastening electronic devices according to the present invention;

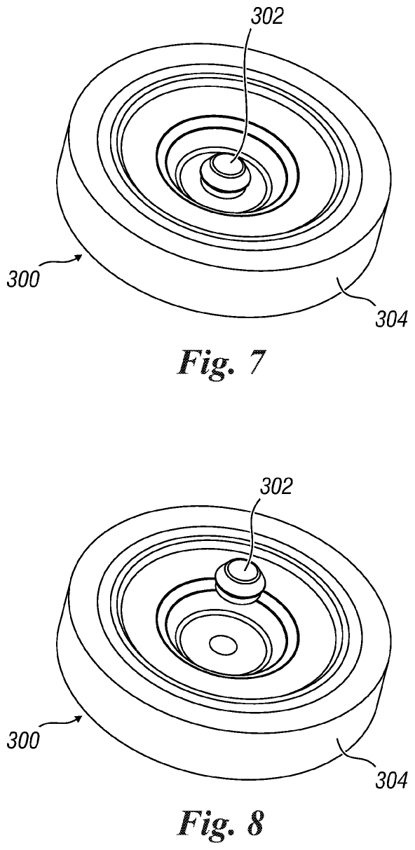

FIG. 7 is a perspective view of a mold usable in the manufacturing method of the element for fastening electronic devices according to the present invention, in which the mold is shown in a first operating configuration;

FIG. 8 is another perspective view of a mold usable in the manufacturing method of the element for fastening electronic devices according to the present invention, in which the mold is shown in a second operating configuration; and

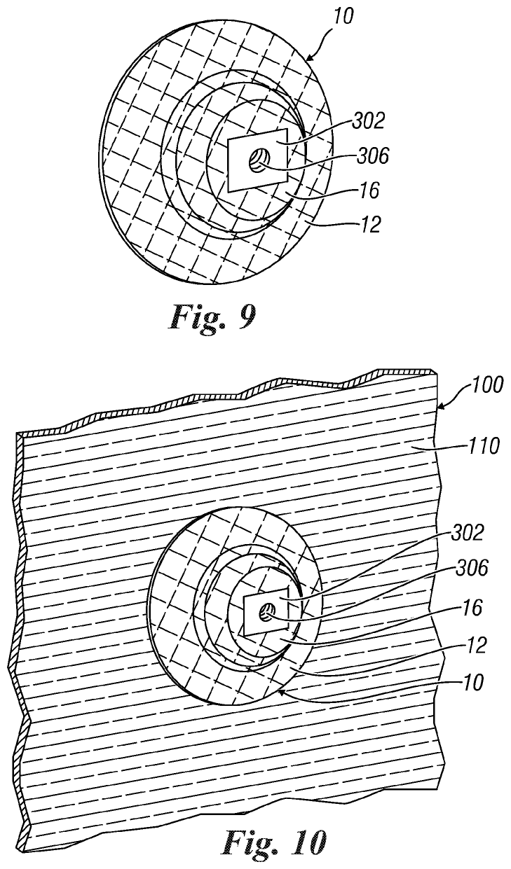

FIGS. 9 to 14 show in sequence the main phases of the manufacturing method of a tire provided with an element for fastening electronic devices according to the present invention.

With reference in particular to FIGS. 1 to 6, a generic tire 100 for wheels of vehicles and some preferred embodiments of the element 10 according to the present invention for the fastening of electronic devices on the tire 100 are shown. The tire 100 can be of any type known per se in the state of the art and can be adapted for use on different classes of vehicles. By way of example, FIGS. 1 and 6 show a portion of tire 100 which is of the type specifically intended for use on agricultural vehicles, but the fastening element 10 and the respective manufacturing method can be indifferently applied also to other types of tires.

Again in a per se known manner, the tire 100 consists of an internally hollow and substantially toroidal-shaped structure. The structure of the tire 100 therefore comprises a pair of axially opposite end flaps 102, 104 with circumferential extension. These end flaps 102, 104, that form the so-called “bead” of the tire 100, are arranged to engage tightly with a rim (not shown) of a vehicle, thus allowing the tire 100 to be fitted on the rim.

The structure of the tire 100 further comprises a circumferential belt structure 106, which is externally provided with a tread portion 108 and is internally provided with an internal base wall 110 of the tire 100. Between the tread portion 108 and the internal base wall 110, a so-called belt package (not shown) can be interposed, normally consisting of an assembly of multiple layers comprising plies made of textile or metallic material, variously interwoven.

The structure of the tire 100 also comprises a pair of sidewalls 112, 114 with circumferential extension. Each sidewall 112, 114 extends between a respective end flap 102, 104 and the belt structure 106. Each sidewall 112, 114 is externally provided with a shoulder portion 116, 118 and is internally provided with an internal side wall 120, 122 of the tire 100. The assembly consisting of the internal base wall 110 and the internal side walls 120, 122 thus forms the so-called inner liner of the tire 100.

The tire 100 is internally provided with at least one fastening element 10 for at least one electronic device 200. The fastening element 10 is technically called a patch. The electronic device 200 is schematically illustrated in FIGS. 2A and 2B, which show two possible embodiments of said electronic device 200 that differ substantially due to their dimensions. Each electronic device 200 can comprise one or more sensors adapted to detect given characteristic parameters of the tire 100, and one or more further appliances adapted to aid the sensors during the operation thereof.

Each fastening element 10, or patch, is made integral with the inner liner of the tire 100 in a respective predefined position. In other words, each fastening element 10 can be made integral with the internal base wall 110 and/or with the internal side wall 120, 122 of the tire 100 in any position suitable for the fastening of a respective electronic device 200 for detecting characteristic parameters of the tire 100.

Each fastening element 10 is made of a deformable elastomeric material, which will be described in further detail below, and comprises a base portion 12 which is provided with a fastening surface 14. The fastening surface 14 is designed to obtain fastening of the fastening element 10 on the internal base wall 110 and/or on the internal side wall 120, 122 of the tire 100, as will be described in further detail below with reference to the manufacturing method of the tire 100 and the respective fastening elements 10.

Each fastening element 10 further comprises a retaining portion 16 for one or more electronic devices 200. This retaining portion 16 is formed in a single piece with the base portion 12 and is provided with an upper surface 18 facing away from the fastening surface 14.

In the retaining portion 16 of the fastening element 10 at least one blind hole 20 is obtained, which extends into said retaining portion 16 and faces the upper surface 18 of said retaining portion 16. Each blind hole 20 is provided with at least one side wall 22 and at least one bottom wall 24.

According to the invention, the base portion 12 of the fastening element 10 has a maximum dimension D1, measured on a plane parallel to the fastening surface 14, which is comprised between 55 mm and 75 mm, while the retaining portion 16 of the fastening element 10 has a minimum dimension D2, measured on a plane parallel to the upper surface 18, which is comprised between 20 mm and 30 mm. According to a preferred aspect of the present invention, the dimension D2 of the retaining portion 16 of the fastening element 10 can be equal to approximately 40% of the dimension D1 of the base portion 12 of the fastening element 10. In addition, the blind hole 20 has a maximum internal width D3 which is less than the dimension D2 of the retaining portion 16.

The particularly reduced dimensions of both the retaining portion 16 of the fastening element 10 and the respective blind hole 20 have been accurately selected in order to accommodate in the blind hole 20 only a limited root portion 202 (FIG. 14), called stud, of the electronic device 200 and not the entire body of the electronic device 200. In particular, the limited planar of the fastening element 10, which coincide with the limited dimensions of the base portion 12 thereof, are such as to minimize at structural level the interference on the electronic device 200 relative to the rolling dynamics of the tire 100 in both directions, with evident gain by the electronic device 200, which is capable of receiving an unchanged signal from the tire 100. Even more in particular, with reference to the minimum dimension D2 of the retaining portion 16 of the fastening element 10 which is responsible for containment of the root portion or stud 202 of the electronic device 200, considering that this retaining portion 16 is the one that can cause a structural interference on the electronic device 200 relative to the rolling dynamics of the tire 100, this minimum dimension D2 allows the retaining portion 16 to have a planar equal to just over half of the mean planar of the retaining portions of the sensors found in the most common patches on the market, said mean planar dimensions being in the order of approximately 45 mm, and in any case normally greater than 40 mm.

In addition, the particularly reduced dimensions of both the retaining portion 16 of the fastening element 10 and the respective blind hole 20, which allow only the root portion or stud 202 of the electronic device 200 to be accommodated and retained, entail the advantage of being capable of using electronic devices 200 having a large variety of geometries and dimensions, without prejudice to the geometry and dimension of the stud 202. This allows the use of a fastening element 10 of a single type to accommodate and retain electronic devices 200 of different types, with evident economic advantages.

With reference to the embodiments shown in FIGS. 1 to 5, the fastening surface 14 of the base portion 12 of the fastening element 10 is a circular surface. Consequently, the maximum dimension D1 coincides with the diameter of this circular fastening surface 14 of the base portion 12 of the fastening element 10.

Again with reference to the embodiments shown in FIGS. 1 to 5, also the upper surface 18 of the retaining portion 16 of the fastening element 10 is a circular surface. Consequently, the minimum dimension D2 coincides with the diameter of this circular upper surface 18 of the retaining portion 16 of the fastening element 10.

With reference to the embodiment shown in FIG. 6, the fastening surface 14 of the base portion 12 of the fastening element 10 is a substantially elliptical surface. Consequently, the maximum dimension D1 coincides in this case with the minor axis of this substantially elliptical fastening surface 14 of the base portion 12 of the fastening element 10, while the major axis of this substantially elliptical fastening surface 14 of the base portion 12 of the fastening element 10 is indicated by D4 in FIG. 6.

Again with reference to the embodiment shown in FIG. 6, also the upper surface 18 of the retaining portion 16 of the fastening element 10 is a substantially elliptical surface. Consequently, the minimum dimension D2 coincides with the minor axis of this substantially elliptical upper surface 18 of the retaining portion 16 of the fastening element 10. In this embodiment, the retaining portion 16 of the fastening element 10 is provided with at least two blind holes 20 instead of only one. The possibility of providing at least two blind holes 20 on the retaining portion 16 of a single fastening element 10 can allow a multiple preparation of electronic devices 200 such as, for example, sensors, batteries, additional modules connected to the main sensors, etc.

Regardless of the number of blind holes 20 present in the fastening element 10, the internal geometry of each of these blind holes 20 is such as to allow the fitting of a respective electronic device 200 without the use of tools such as, for example, forceps for opening the inner volume housing the entire electronic device 200, which are necessary when patches are used as disclosed in prior art document EP-A-3774407. In particular, the internal geometry of each blind hole 20 of the fastening element 10 according to the present invention entails the presence of a shape constraint between the root portion or stud 202 of the electronic device 200 and the blind hole 20. This shape constraint is obtained by means of an appropriate undercut obtained in each blind hole 20. The undercut is such as to allow easy manual insertion/disinsertion of the electronic device 200, without affecting the structural integrity of the fastening element 10. This is particularly important in the case of malfunctions and replacements of the electronic device 200.

In detail, according to the invention, at least a side wall 22 of each blind hole 20 comprises:
a first top portion 26, which faces the upper surface 18 of the retaining portion 16 of the fastening element 10;
a second internal portion 28, which extends between the first top portion 26 and the bottom wall 24 of the blind hole 20; and
an undercut portion 30, which is interposed between the first top portion 26 and the second internal portion 28 and which is substantially parallel to the upper surface 18 of the retaining portion 16.

Furthermore, the maximum internal width D3 of each blind hole 20 coincides with the maximum width of the undercut portion 30 thereof. Again according to the invention, as shown in FIG. 3, the second internal portion 28 of each blind hole 20 has a tapered shape, with a width progressively decreasing from the undercut portion 30 towards the bottom wall 24.

With reference to the embodiment of FIG. 4, the first top portion 26 of each blind hole 20 can have a cross-sectional shape, that is, a section obtained along a plane parallel to the upper surface 18 of the retaining portion 16, which is substantially circular. With reference to the embodiment of FIG. 5, the first top portion 26 of each blind hole 20 can have a cross-sectional shape which is substantially rectangular, or more generally, not circular. However, it is possible for the first top portion 26 of each blind hole 20 to have different cross-sectional shapes, compatibly with the shape of the root portion or stud 202 of the electronic device 200.

If the first top portion 26 of each blind hole 20 has a cross-sectional shape which is substantially rectangular, it is possible to associate with this rectangle a two-dimensional Cartesian reference system x, y (FIG. 5), in such a way that two of the orthogonal sides in this rectangle coincide with the x and y axes respectively. In this case the shape constraint between the root portion or stud 202 of the electronic device 200 and the blind hole 20 is obtained not only by means of the undercut obtained in each blind hole 20, but also thanks to the cross-sectional shape of the blind hole 20, which allows the electronic device 200 to be oriented according to predefined directions of the two-dimensional Cartesian reference system x, y.

With reference now to FIGS. 9 to 14, the main phases of the manufacturing method of a tire 100 provided with one or more fastening elements 10 for fastening electronic devices 200 of the type described so far will be described. The method entails a preliminary phase in which a raw, that is, non-vulcanized, tire 100 is provided ready for insertion into the press, namely, the pressurized vulcanization chamber in which the vulcanization process is performed.

Production of the fastening element 10 is carried out separately from the process of preparation of the tire 100, which remains unchanged. A mold 300 is therefore prepared (FIGS. 7 and 8) provided with a molding imprint coinciding with the shape of the fastening element 10. In detail, the mold 300 is advantageously of modular type, namely it consists of at least two separable components. These separable components comprise a main body 304 of the mold 300 and at least a molding body 302 of the mold 300. Each molding body 302 of the mold 300 is arranged to form a corresponding blind hole 20 of the fastening element 10 and can be separated from the main body 304 of the mold 300. The mold 300 can be made in such a way as to be compatible with the most common molding processes of elastomeric materials such as, for example, pressure molding or injection molding.

Once the mold 300 has been prepared, a raw elastomeric material is applied on the mold 300, so that this raw elastomeric material covers at least partially both each molding body 302 of the mold 300 and the main body 304 of the mold 300. The raw elastomeric material applied on the mold 300 is then vulcanized to obtain the fastening element 10 in its final form.

Following the vulcanization process, the vulcanized fastening element 10 is removed from the main body 304 of the mold 300. In this phase, however, the vulcanized fastening element 10 keeps therein each single molding body 302 of the mold 300, which is then separated from the main body 304 of the respective mold 300 (FIG. 9). In other words, each single molding body 302 of the mold 300 is kept inside the respective blind hole 20 of the vulcanized fastening element 10 during extraction of the latter from the main body 304 of the respective mold 300.

The vulcanized fastening element 10 is therefore ready for application on the raw tire 100. In particular, the fastening surface 14 of each vulcanized fastening element 10 is made to adhere on the internal base wall 110 and/or on the internal side wall 120, 122 of the raw tire 100, as shown for example in FIG. 10. Preferably, the application phase of each vulcanized fastening element 10 on the internal base wall 110 and/or on the internal side wall 120, 122 of the raw tire 100 is preceded by the addition of a soluble hydrocarbon used as a solvent, in order to improve the adhesion of each vulcanized fastening element 10 on the internal base wall 110 and/or on the internal side wall 120, 122 of the raw tire 100.

The assembly consisting of the raw tire 100 and the one or more already vulcanized fastening elements 10 can then be vulcanized in turn, obtaining the configuration of FIG. 12, namely the union in one single body of the tire 100 and the one or more fastening elements 10. Compared to the application of vulcanized fastening elements on already vulcanized tires, this step of the method avoids having to carry out additional operations on the fastening element 10 such as, for example, rasping and gluing. However, one or more of these additional operations can be carried out on at least part of the fastening elements 10 if required by the construction needs of the tire 100.

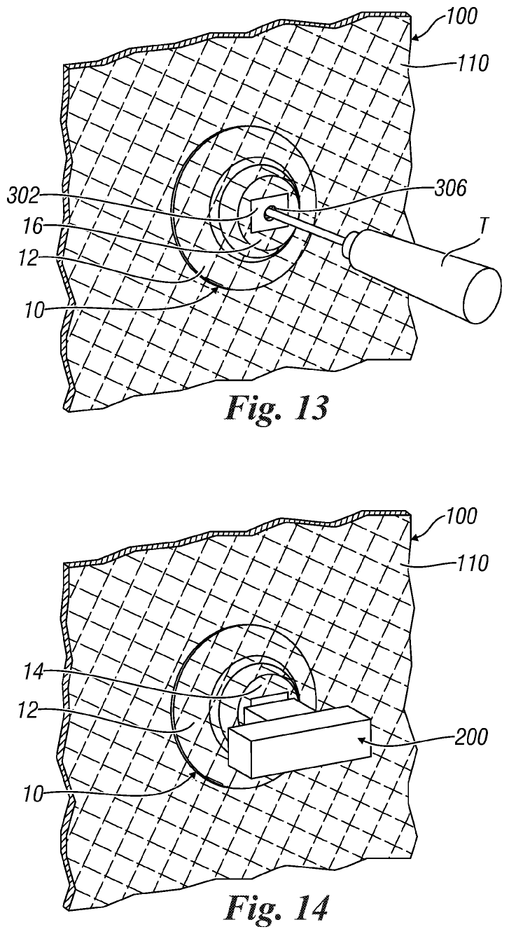

Once the vulcanization step of the assembly consisting of the tire 100 and the one or more already vulcanized fastening elements 10 has been completed, it is possible to remove each molding body 302 of the mold 300 from the respective blind hole 20 of each fastening element 10. For said purpose, each molding body 302 of the mold 300 can be advantageously provided with at least one connecting portion 306 (visible in FIGS. 9-12) for connection with an extraction tool T, as shown in FIG. 13. In this way, a connection between the above-mentioned extraction tool T and the connecting portion 306 of the molding body 302 of the mold 300 allows said molding body 302 to be removed from the respective blind hole 20 of each fastening element 10 after the vulcanization step of the assembly consisting of the tire 100 and of the one or more already vulcanized fastening elements 10. Preferably, each connecting portion 306 can consist of a quick coupling and uncoupling mechanism, in such a way that the extraction tool T can be specifically shaped to interact with said quick coupling and uncoupling mechanism.

The characteristic of the mold 300 of having at least one molding body 302 separable from the respective main body 304, so that this molding body 302 remains inside a respective blind hole 20 of the fastening element 10 in all the vulcanization steps, avoids damage to the fastening element 10 and, in particular, possible deformation of the respective blind hole 20 both in the application phase of the vulcanized fastening element 10 on the raw tire 100 and in the subsequent vulcanization step of the assembly consisting of the raw tire 100 and the one or more already vulcanized fastening elements 10. Furthermore, this characteristic of the mold 300 of having at least a molding body 302 separable from the respective main body 304 avoids having to insert a posteriori, in each blind hole 20, a dummy stud (namely, a disposable accessory that is not included in the mold 300 and that has the shape and dimensions of the root portion or stud 202 of the electronic device 200) only in the vulcanization step of the tire 100. This considerably reduces, with an estimated reduction of up to 20%, the preparation times of the raw tire 100 for subsequent insertion thereof into the vulcanization chamber. Last but not least, a molding body 302 separable from the respective main body 304 avoids damage to the bladder present inside the vulcanization chamber of the press, since it ensures the coplanarity of the molding body 302 with the upper surface 18 of the fastening element 10. Therefore, during the pressing step, the bladder does not sustain damage connected with sharp edges that can risk puncturing the bladder.

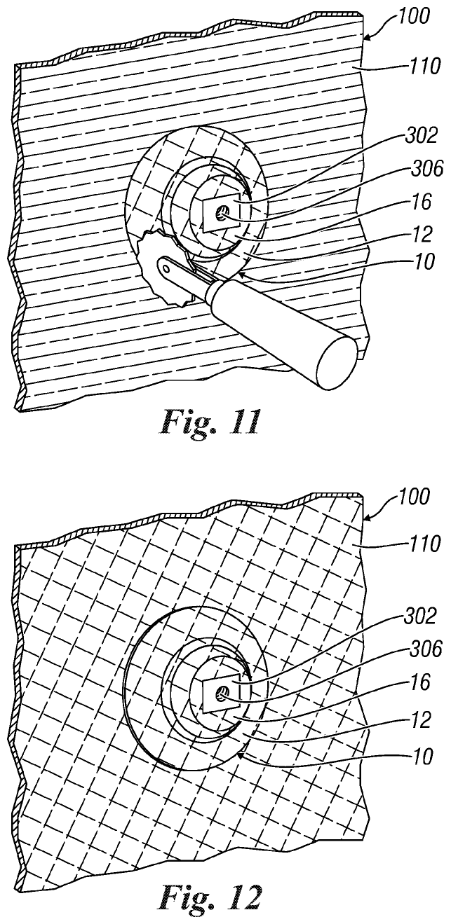

In addition, the fact of applying each already vulcanized fastening element 10 on the tire 100 still to be vulcanized allows this application step to be performed by simply using a manual tool such as, for example, the roller shown in FIG. 11. In other words, there is no need for complex preliminary operations during the manufacturing process of the raw tire 100 such as, for example, specific shaping of the manufacturing drum of the tire 100, which would be necessary if each fastening element 10 were incorporated already during the manufacturing process of the raw tire 100. A manual operation lasting a few seconds thus avoids significant investment costs, in addition to a manufacturing “rigidity” of the tire 100 originating from the need to provide drums with and without equipment for application of the fastening elements 10. Furthermore, the fact of applying each already vulcanized fastening element 10 on the tire 100 still to be vulcanized avoids the affixing of rigid spacer elements, designed to maintain the shape of the fastening element 10 during the vulcanization step in the press, thus further reducing investment costs and process times.

Once preparation of the assembly consisting of the tire 100 and the one or more fastening elements 10 has been completed, both already vulcanized and with each blind hole 20 of each fastening element 10 without the respective molding body 302 of the mold 300, it is possible to insert at least a portion of a single electronic device 200 in a corresponding blind hole 20 of a given fastening element 10. In detail, as shown in FIG. 14, this portion of the electronic device 200 consists solely of the root portion or stud 202 of the electronic device 200 and not the entire body of said electronic device 200.

Preferably, the elastomeric material of which each fastening element 10 is made consists of a mixture comprising the following main components:

| component | phr |
|---|---|
| synthetic rubber | 70-80 |
| natural rubber | 30-20 |
| carbon black within N2xx series | 60-70 |
| oil plasticizer | 10-20 |
| TOTAL | 170-190 |

The acronym “phr” (“parts per hundred rubber”) indicates the parts of each component per 100 parts of rubber. The acronym “N2xx” indicates all the values of the N200 carbon black series according to the USA ASTM standard such as, for example, N220, N234, etc.

Even more preferably, the synthetic rubber can be chosen from the group comprising:
polybutadiene rubber (PB);
styrene-butadiene rubber (SBR);
styrene-butadiene rubber produced by emulsion polymerization (E-SBR).

The choice of the elastomeric component material of each fastening element is linked to its hardness and abrasion characteristics, together with the simplicity of the vulcanization step of the fastening element 10 and the subsequent adhesion step of the vulcanized fastening element 10 to the raw tire 100. In addition, the particular combination of this preferred elastomeric material and the specific shape and dimensions of the fastening element 10 in any case avoids situations of heat 10 dissipation such as to compromise the integrity of the tire 100 in conditions of high-performance use.

It can therefore be seen that the element for fastening electronic devices on a tire and the manufacturing method of a tire provided with said fastening element according to the present invention achieve the purposes previously highlighted. The element for fastening electronic devices on a tire and the respective manufacturing method not only allow perfect adhesion of the fastening element on the tire and optimal functioning of the electronic devices; considering the reduced dimensions of the fastening element and its particular manufacturing method, the effects on the tire due to the presence of the fastening elements and the electronic devices supported thereby are negligible. In particular, based on experimental tests carried out by the applicant:
the rolling dynamics of the tire are not altered by the presence of the fastening elements and the electronic devices supported thereby;
any forces measured by means of test equipment adapted to quantify the radial force variation for given tire rolling speed values are not influenced by the presence of the fastening elements and the electronic devices supported thereby;
the driver and/or the occupants of the vehicle on which tires are fitted provided with the fastening elements and the electronic devices supported thereby do not notice appreciable differences compared to the use of tires without the fastening elements and the electronic devices supported thereby;
the presence of the fastening elements and the electronic devices supported thereby does not negatively affect the durability of the fastening elements, or of the tire on which these fastening elements are applied.

The element for fastening electronic devices on a tire of the present invention thus conceived is subject in any case to numerous modifications and variations, all falling within the same inventive concept; furthermore, all the details can be replaced by technically equivalent elements. In practice, any materials, shapes and dimensions can be used according to technical requirements.

The scope of protection of the invention is therefore defined by the attached claims.

1. A tire for vehicle wheels, consisting of an internally hollow and substantially toroidal-shaped structure, said structure comprising:
a pair of axially opposite end flaps with circumferential extension, which are arranged to engage tightly with a rim of a vehicle to allow said tire to be fitted on said rim;
a circumferential belt structure, which is externally provided with a tread portion and is internally provided with an internal base wall of the tire;
a pair of sidewalls with circumferential extension, wherein each sidewall extends between a respective end flap and said belt structure, and wherein each sidewall is externally provided with a shoulder portion and is internally provided with an internal side wall of the tire; and
at least one fastening element for at least one electronic device, which is made integral with said internal base wall and/or with said internal side wall of the tire,
wherein each fastening element is manufactured from a deformable elastomeric material and comprises:
a base portion, which is provided with a fastening surface fastened on said internal base wall and/or on said internal side wall of the tire;
a retaining portion, which is integrally formed in a single piece with said base portion and is provided with an upper surface facing away from said fastening surface; and
at least one blind hole, which extends into said retaining portion and faces said upper surface, wherein each blind hole is provided with at least one side wall and at least one bottom wall,
wherein said base portion has a maximum dimension, measured on a plane that is parallel to said fastening surface, wherein said retraining portion has a minimum dimension, measured on a plane parallel to said upper surface, and wherein said blind hole has a maximum internal width which is less than said minimum dimension, the tire wherein said maximum dimension is comprised between 55 mm and 75 mm and said minimum dimension is comprised between 20 mm and 30 mm, wherein said at least one side wall of said blind hole comprises:
a first top portion, which faces said upper surface;
a second inner portion, which extends between said first top portion and said bottom wall; and
an undercut portion, which is interposed between said first top portion and said second inner portion and is substantially parallel to the upper surface of said retaining portion,
wherein the maximum internal width of said blind hole coincides with the maximum width of said undercut portion, and wherein the second inner portion of said blind hole has a tapered shape, with a progressively decreasing width from said undercut portion towards said bottom wall.

2. The tire according to claim 1, wherein the minimum dimension of said retaining portion is equal to approximately 40% of the maximum dimension of said base portion.

3. The tire according to claim 1, wherein the fastening surface of said base portion is a circular surface, so that said maximum dimension of said base portion coincides with the diameter of said circular fastening surface.

4. The tire according to claim 3, wherein the upper surface of said retaining portion is a circular surface, so that said minimum dimension of said retraining portion coincides with the diameter of said circular upper surface.

5. The tire according to claim 1, wherein the fastening surface of said base portion is a substantially elliptical surface, so that said maximum dimension of said base portion coincides with the minor axis of said substantially elliptical fastening surface.

6. The tire according to claim 5, wherein the upper surface of said retaining portion is a substantially elliptical surface, so that said minimum dimension of said retraining portion coincides with the minor axis of said substantially elliptical upper surface.

7. The tire according to claim 5, wherein said retaining portion is provided with at least two blind holes.

8. The tire according to claim 1, wherein the first top portion of said blind hole has a cross-sectional shape, that is, a section obtained along a plane which is parallel to the upper surface of said retaining portion, which is substantially circular.

9. The tire according to claim 1, wherein the first top portion of said blind hole has a cross-sectional shape, that is, a section obtained along a plane parallel to the upper surface of said retaining portion, which is non-circular.

10. A method for manufacturing a tire provided with at least one fastening element according to claim 1, the method comprising the steps of:
preparing a raw, that is, non-vulcanized, tire;
preparing a mold provided with a molding imprint coinciding with the shape of said fastening element, wherein at least one molding body of said mold, which is designed to form said blind hole, can be separated from the main body of said mold;
applying a raw elastomeric material on said mold, in such a way that said raw elastomeric material at least partially covers said at least one molding body and said main body of said mold;
vulcanizing said raw elastomeric material applied on said mold to obtain said fastening element;
removing said vulcanized fastening element from the main body of said mold, in such a way that said vulcanized fastening element keeps therein said at least one molding body, which is then separated from the main body of said mold;
applying one or more vulcanized fastening elements on the raw tire, so that the fastening surface of each fastening element adheres to the internal base wall and/or to the internal side wall of said raw tire;
vulcanizing the assembly consisting of said raw tire and said one or more already vulcanized fastening elements;
removing said at least one molding body from the respective blind hole of each fastening element;
inserting at least one portion of said electronic device into the blind hole of said fastening element, in such a way that said at least one portion of said electronic device only consists of a root portion of said electronic device and not the whole body of said electronic device.

11. The method according to claim 10, wherein said at least one molding body is provided with at least one connecting portion for connection with an extraction tool, such way that a connection between said extraction tool and said at least one connecting portion allows to remove said at least one molding body from the respective blind hole of each fastening element after the vulcanization step of the assembly consisting of said tire and said one or more fastening elements.

12. The method according to claim 11, wherein said connecting portion consists of a quick coupling and uncoupling mechanism.

13. The method according to claim 10, wherein the step of applying each fastening element vulcanized on the internal base wall and/or on the internal side wall of said raw tire is preceded by the addition of a soluble hydrocarbon used as a solvent, in order to improve the adhesion of each fixing element vulcanized on the internal base wall and/or on the internal side wall of said raw tire.

14. The method according to claim 10, wherein said elastomeric material consists of a mixture comprising the following main components:

| component | phr |
|---|---|
| synthetic rubber | 70-80 |
| natural rubber | 30-20 |
| carbon black within N2xx series | 60-70 |
| oil plasticizer | 10-20 |
| TOTAL | 170-190 |

15. The method according to claim 14, wherein said synthetic rubber is selected from the group comprising:
polybutadiene rubber (PB);
styrene-butadiene rubber (SBR);
styrene-butadiene rubber produced by emulsion polymerization (E-SBR).

16. The tire according to claim 2, wherein the fastening surface of said base portion is a circular surface, so that said maximum dimension of said base portion coincides with the diameter of said circular fastening surface.

17. The tire according to claim 16, wherein the upper surface of said retaining portion is a circular surface, so that said minimum dimension of said retraining portion coincides with the diameter of said circular upper surface.

18. The tire according to claim 1, wherein the first top portion of said blind hole has a cross-sectional shape, that is, a section obtained along a plane parallel to the upper surface of said retaining portion, which is rectangular.
